(19) United States
(12) Patent Application Publication
(10) Pub. No.: US 2013/0053291 A1
(43) Pub. Date: Feb. 28, 2013

(54) COMPOSITION FOR CLEANING SUBSTRATES POST-CHEMICAL MECHANICAL POLISHING

(71) Applicants: Atsushi Otake, Kawasaki-shi (JP); Paul R. Bernatis, Hayward, CA (US); Cass X. Shang, Sunnyvale, CA (US)

(72) Inventors: Atsushi Otake, Kawasaki-shi (JP); Paul R. Bernatis, Hayward, CA (US); Cass X. Shang, Sunnyvale, CA (US)

(21) Appl. No.: 13/214,920

(22) Filed: Aug. 22, 2011

(51) Int. Cl. C11D 3/60; C11D 7/60

(52) U.S. Cl. 510/175

(57) ABSTRACT

A semiconductor processing composition and method for cleaning semiconductor wafers post chemical mechanical polishing comprising a phosphorous base and optionally at least one surfactant.

### BACKGROUND OF THE INVENTION

The presently disclosed and claimed inventive concept(s) relates to a composition and method for removing unwanted particles and residues from the surface of an object, and, more particularly, to a semiconductor processing composition and method for cleaning a semiconductor wafer or related other substrate post chemical mechanical polishing (CMP). The composition comprises a phosphonium hydroxide base, such as tetrabutylphosphonium hydroxide, and has shown surprising results in terms of substantially reduced defect counts.

Chemical mechanical polishing (CMP) has become the predominant process for planarization of semiconductor wafers and other related substrates, such as insulation films and metallic materials. CMP demonstrates an apparent synergistic effect that has been observed from carefully selected physical and chemical components to ensure uniform polishing of wafers. A load force is applied to the back of a wafer resting on a rotatable pad, followed by counter-rotation of the pad (and wafer) while a slurry containing abrasives (the physical component) and reactive chemicals is passed underneath the counter-rotating pad.

The primary purpose of CMP is to obtain a uniform and global planarization across the entire surface of a semiconductor wafer or other substrate. With respect to semiconductor wafers, the wafers may consist of many small dies and patterns which typically take the form of interconnected lines of copper and an oxide, such as silicon dioxide (also referred to as “interconnects”). Global planarization occurs when a uniform topography is achieved over the entire wafer causing it to be completely flat or planar (i.e., the interconnects are polished to the point where both the copper and silica lines are at the same level).

The slurry of abrasives and chemicals is selected to simultaneously react with and/or weaken the material to be removed from the wafer during planarization. The slurry used in metal CMP (i.e., copper CMP) is typically a combination of abrasive particles (including, but not limited to, alumina, silica, manganese dioxide, cerium oxide, zirconium oxide, etc.) and an oxidizer (such as, but not limited to, iron(III) nitrate, aqueous hydrogen peroxide, etc.). It is not uncommon for amine and nitrogen-containing compounds to be used in the CMP process, however these compounds have been observed to be more prone to causing manufacturing defects when or if they become trapped within the interconnects of the semiconductor wafer (i.e., causing resist poisoning). Nitrogen (i.e., nitrogen atoms) and nitrogen-containing compound impurities can contaminate the production line and deteriorate or destroy the desirable electrical properties of the wafer itself.

Consequently, the impurities and particles adhering to the substrate during the CMP process need to be effectively and speedily removed before the wafer can be further processed. The removal process is referred to as post-CMP cleaning. Post-CMP cleaning formulations presently use nitrogen base to adjust the pH of the cleaning solution, which, in turn, can result in introduction of undesirable amine and other nitrogen-containing compounds into the manufacturing process thereby causing resist poisoning of the wafer. A need, therefore, exists for a nitrogen-free composition (and method) that effectively cleans post-CMP residue and particles from the semiconductor

wafer substrate, and that does not introduce nitrogen-containing compounds onto the wafer surface.

### SUMMARY OF THE INVENTION

The presently claimed and disclosed inventive concept(s) relate to a semiconductor processing composition and method for cleaning a semiconductor wafer or related other substrate post chemical mechanical polishing. The composition comprises at least one phosphorous containing base and, optionally, at least one surfactant.

Embraced within the claimed and disclosed inventive concepts giving rise to the invention is an improved nitrogen-free semiconductor processing composition which comprises at least one phosphorous containing base and that may optionally contain one or more other components selected from a phoshonic acid and/or a surfactant, e.g., nonionic, cationic, anionic.

The processing composition of the invention is particularly well suited for post-CMP cleaning (i.e., post chemical mechanical polishing) to remove CMP residue from the surface of an object to be cleaned, e.g., from the surface of a semiconductor wafer. Accordingly, within the presently claimed and disclosed inventive concept(s) is a method of post-CMP cleaning to remove a CMP residue from a surface of an object comprising the steps of: (a) forming a nitrogen-free processing composition comprising at least one phosphorous containing base; and (b) contacting the surface of the object with the processing composition whereby a primary, i.e., material, portion of the CMP residue is removed from the surface of the object.

### BRIEF DESCRIPTION OF THE DRAWINGS

FIGS. 1, 2 and 3 are graphs of total defect counts corresponding to experimental formulations A through O in the Examples which follow.

### DETAILED DESCRIPTION OF THE INVENTION

The presently claimed and disclosed inventive concept(s) relate to and define an improved semiconductor processing composition and method for cleaning a semiconductor wafer or related other substrate post chemical mechanical polishing. The composition comprises (i) at least one phosphorous containing base, and, optionally, (ii) at least one surfactant. Preferably, the composition is nitrogen-free and exhibits a negative zeta potential.

The term “nitrogen-free” is used herein to mean that the composition does not contain nitrogen containing acids, nitrogen containing bases, or any other components or compounds that would introduce nitrogen atoms into the formulation.

The term “zeta potential” is used herein to mean the electrokinetic potential of colloidal systems comprising a processing composition. Colloidal systems of the type contemplated herein also comprise typical abrasive particles for CMP slurries. The zeta potential is the potential difference between the processing composition (i.e., the dispersion medium) and the stationary layer of fluid attached to the abrasive particle or wafer surface. The zeta potential indicates the degree of repulsion between similarly charged particles or particles and the surface of the wafer immersed in the cleaning composition. It is believed, and observations support a conclusion, that particle/residue removal performance of a processing composition can be predicted by zeta potential. For instance, a processing composition having a negative zeta potential with colloidal silica has been found to exhibit exemplary particle/residue removal from a substrate. For best results, the negative zeta potential of the processing composition is preferably in a range of from about −80 to about −30 millivolts (mV), although this range can vary upward or downward so long as the variation does not detract from achieving optimum particle/residue removal. As noted above, the zeta potential indicates the degree of repulsion between adjacent, similarly charged particles or particles and the wafer surface in a dispersion. Furthermore, if zeta potential is higher than −10 millivolts (mV), abrasive particles easily aggregate to each other and/or attach to a substrate surface, which makes them more difficult to remove. If the zeta potential is lower than −10 millivolts (mV), preferably −30 millivolts (mV), abrasive particles are generally stable in the dispersed phase.

The semiconductor processing composition, or formulation, of the invention contains at least one phosphorus base, such as, by way of example and not by limitation, a phosphonium hydroxide base. As noted above, the composition may also contain one or more additional components selected from phosphonic acids which have been shown to be excellent chelators with metal ions (thus facilitating metal ion removal from the substrate). Phosphonium hydroxide bases blended with phosphonic acids do not introduce nitrogen atoms into the formulation, thus maintaining a very desirable nitrogen-free environment and formulation. While a number of various phosphonic acids may be suitable to accomplish the objectives of the presently disclosed and claimed inventive concept(s), the preferred phosphonic acid for use in the processing composition is ‘1-hydroxyethylidene-1,1-diphosphonic acid (HEDP). Phosphonium hydroxide bases (and likewise, the phosphonic acids) are used to adjust the pH of the processing composition/formulation. While a number of phosphorus bases may be used to accomplish this objective, the preferred phosphorus base is a phosphonium hydroxide, and even more preferred for consistent satisfactory performance is tetrabutylphosphonium hydroxide.

Surfactants enhance the wetting properties of the processing composition (i.e., the presence of one or more surfactants lowers the surface tension of the processing composition, which, in turn, allows the processing composition to more easily spread over the object or substrate surface). In addition, nonionic surfactants typically function as detergent micelles at higher concentrations. Thus, the wetting properties and detergent micelle formation associated with nonionic surfactants increase the ability of the processing composition to remove residue/particles from the object/substrate, e.g., from the semiconductor wafer surface. Nonionic surfactants suitable for use in the processing composition described herein include, but are not limited to, polyethylene glycol, alkyl polyglucoside (i.e., Triton BG-10 and Triton CG-110 surfactants manufactured by the Dow Chemical Company), octylphenol ethoxylate (i.e., Triton X-114 manufactured by Dow Chemical Company), silane polyalkyleneoxide (copolymer) (i.e., Y-17112-SGS sample manufactured by Momentive Performance Materials), nonylphenol ethoxylate (i.e., Tergitol NP-12 manufactured by Dow Chemical Company), Silwet® HS-312 (manufactured by Momentive Performance Materials), and tristyrlphenol ethoxylate (i.e., MAKON TSP-20 manufactured by Stepan Company), polyoxyethylene alkyl ether, polyoxyethylene alkylphenyl ether, alkylallyl formaldehyde condensated polyoxyethylene ether, polyoxyethylene polyoxypropylene block polymer, polyoxyethylene polyoxypropylene alkyl ether, polyoxyethylene ether of glycerin ester, polyoxyethylene ether of sobitan ester, and polyoxyethylene ether of sorbitol ester, polyethylene glycol fatty acid ester, glycerin ester, polyglycerin ester, sorbitan ester, propylene glycol ester, sucrose ester, aliphatic acid alkanol amide, polyoxyethylene fatty acid amide, polyoxyethylene alkyl amide, nonyl phenol ethoxylates such as TRITON® X-114, X-102, X-100, X-45, X-15, BG-10, CG-119, alcohol ethoxylates such as BRIJ® 56 (C₁₆H₃₃(OCH₂CH₂)₁₀OH), BRIJ® 58 (C₁₆H₃₃(OCH₂CH₂)₂₀OH), BRIJ® 35 (C₁₂H₂₅(OCH₂CH₂)₂₃OH), alcohol (primary and secondary) ethoxylates, amine ethoxylates, glucosides, glucamides, polyethylene glycols, poly(ethylene glycol-co-propylene glycol), cetyl alcohol, stearyl alcohol, cetostearyl alcohol (consisting predominantly of cetyl and stearyl alcohols), oleyl alcohol, octaethylene glycol monododecyl ether, pentaethylene glycol monododecyl ether, polyoxypropylene glycol alkyl ethers, decyl glucoside, lauryl glucoside, octyl glucoside, polyoxyethylene glycol octylphenol ethers, nonoxynol-9, glycerol alkyl esters, glyceryl laurate, polyoxyethylene glycol sorbitan alkyl esters: polysorbates; sorbitan alkyl esters, spans, cocamide MEA, cocamide DEA, dodecyldimethylamine oxide, block copolymers of polyethylene glycol, polypropylene glycol, and silane polyalkyleneoxide (copolymer) such as Silwet® HS-312, Y-17112-SGS (manufactured by Momentive Performance Materials), or combinations and mixtures thereof.

Anionic surfactants suitable for use in the post-CMP processing composition described herein include, but are not limited to, alkylbenzene sulfonic acid and salts thereof, such as dodecyl benzene sulfonic acid and ammonium dodecyl benzene sulfonate; alkylnaphthalene sulfonic acid and salts thereof, such as propyl naphthalene sulfonic acid, and triisopropyl naphthalene sulfonic acid; alkylphenyl ether disulufonic acid, such as dodecylphenyl ether disulfonic acid, alkyldiphenylether sulfonic acid and salts thereof; alkyldiphenylether disulfonic acid and salts thereof, such as docecyl diphenyl ether disulfonic acid, and ammonium dodecyl diphenyl ether sulfonate; phenol sulfonic acid-formalin condensate and salts thereof; arylphenol sulfonic acid-formalin condensate and salts thereof; carboxylic acid salt, such as decane carboxylic acid, N-acylamino acid salt, polyoxyethylene or polyoxypropylene alkyl ether carboxylic acid salt; acylated peptide; sulfonic acid salt; sulfuric acid ester salt, such as sulfated oil, alkyl sulfate salt, alkyl ether sulfate salt, polyoxyethylene or polyoxypropylene alkyl allyl ether sulfate salt, alkylamide sulfate salt, phosphoric acid ester salt; alkyl phosphate salt; and polyoxyethylene or polyoxypropylene alkyl allyl ether phosphate salt; ammonium lauryl sulfate; sodium lauryl sulfate (SDS, sodium dodecyl sulfate); sodium laureth sulfate, also known as sodium lauryl ether sulfate (SLES); sodium myreth sulfate; dioctyl sodium sulfosuccinate; octanesulfonate; perfluorooctanesulfonate (PFOS); perfluorobutanesulfonate; alkyl benzene sulfonates; alkyl aryl ether phosphate; alkyl ether phosphate; alkyl carboxylates; fatty acid salts (soaps); sodium stearate; sodium lauroyl sarcosinate; perfluorononanoate; perfluorooctanoate; and mixtures thereof.

Cationic surfactants suitable for use in the post-CMP processing composition described herein include, but are not limited to, octenidine dihydrochloride, alkyltrimethylammonium salts, cetyl trimethylammonium bromide (CTAB), hexadecyl trimethyl ammonium bromide, cetyl trimethylammonium chloride (CTAC), cetylpyridinium chloride (CPC), polyethoxylated tallow amine (POEA), benzalkonium chloride (BAC), benzethonium chloride (BZT), 5-bromo-5-nitro-1,3-dioxane, dimethyldioctadecylammonium chloride, dioctadecyldimethylammonium bromide (DODAB), aliphatic amine salt; aliphatic quaternary ammonium salt; benzal conium chloride salt; benzethonium chloride; pyridinium salt, and imidazolinium salt, amphoteric surfactant carboxybetaine type, sulfobetaine type, aminocarboxylic acid salt, imidazolinium betaine, lecithin, alkylamine oxide, and mixtures thereof.

As noted above, the semiconductor processing composition of the invention is particularly well suited for post-CMP cleaning (i.e., post chemical mechanical polishing) to remove CMP residue from the surface of a semiconductor wafer. Accordingly, embraced within the presently claimed and disclosed inventive concept(s) is a method for post-CMP cleaning to remove CMP residue from a surface of an object comprising the steps of: (a) forming a nitrogen-free processing composition comprising: (i) at least one phosphorous base, and, optionally, (ii) at least one non-ionic surfactant, wherein the composition optimally, but not necessarily, exhibits a negative zeta potential, and (b) contacting the surface of the object with the processing composition to remove at least a portion of the CMP residue from the surface of the object.

### EXAMPLES

Component materials for polishing testing and chemicals for the experimental formulations A through O which follow were obtained from sources indicated below.

### Polishing pad: Rohm and Haas EU4000

### Slurry: DuPont Air Products and Nanomaterials CoppeReady® 4366

Blanket Cu films on 200 mm silicon wafers: SVTC Technologies L.L.C.
60% aqueous solution of 1-hydroxyl ethylidene-1,1-diphosphonic acid (HEDP): Thermophos Japan.
25% aqueous solution of tetramethylammonium hydroxide (TMAH): SACHEM, Inc.
40% aqueous solution of tetrabutylphosphonium hydroxide (TBPH): Tokyo Chemical Industry CO., LTD.

### Triton BG10, Triton X114 and Triton X100: The Dow Chemical Company

PEG (C13EO10), Polyoxoethylene (10) tridecylether: Sigma-Aldrich Co.

### Experimental Results for Polishing and Post-CMP Cleaning

Polishing experiments were carried out on Applied Mirra 200 mm CMP tool with a standard polishing recipe, the types of such recipes being known to those skilled in the art. The polishing pad was conditioned using a diamond grit pad conditioner before every polishing experiment. After polishing, post CMP cleaning experiments were carried out on Lam Ontrak cleaning tool with a standard cleaning recipe with PVA cleaning brushes. The experimental formulations are set forth in Tables 1, 2 and 3.

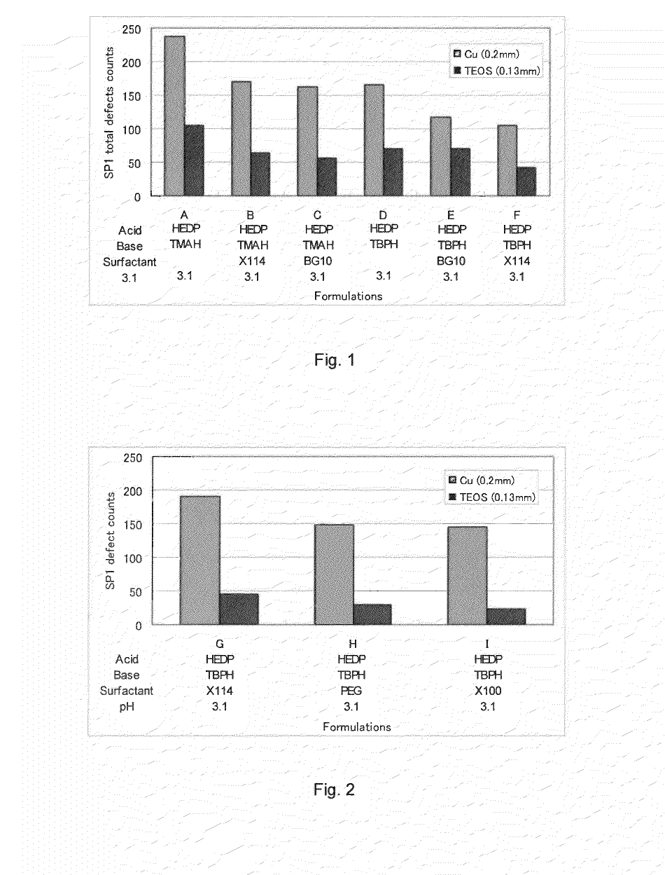

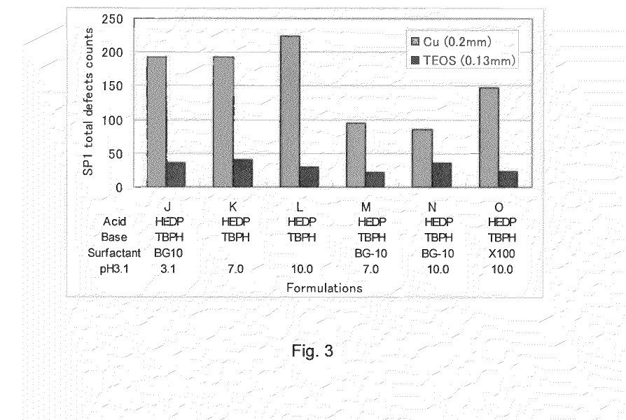

The wafers were then scanned on a KLA-Tencor Surfscan SP1. The SP1 recipe was set up with a threshold of 0.15 μm for characterizing the defectivity of the post-CMP cleaned wafers. The defectivity number is also shown in FIGS. 1, 2 and 3.

TABLE 1

| | Formulations | | | | | |
|---|---|---|---|---|---|---|
| | A | B | C | D | E | F |
| HEDP | 0.0063 | 0.0038 | 0.0063 | 0.0063 | 0.0063 | 0.0063 |
| TMAH | 0.0048 | 0.0029 | 0.0048 | | | |
| TBPH | | | | 0.0143 | 0.0143 | 0.0143 |
| Triton BG10 | | | 0.007 | | 0.007 | |
| Triton X114 | | 0.015 | | | | 0.025 |
| PEG (C13EO10) | | | | | | |
| Triton X100 | | | | | | |
| pH | 3.1 | 3.1 | 3.1 | 3.1 | 3.1 | 3.1 |
| Cu (0.2 μm) | 238 | 171 | 162 | 166 | 117 | 104 |
| TEOS (0.13 μm) | 105 | 64 | 56 | 71 | 71 | 42 |

Formulations which contained tetrabutylphosphonium hydroxide (TBPH) do not contain any nitrogen compounds, and, with reference to FIG. 1, they exhibited lower defects counts than conventional TMAH formulations.

TABLE 2

| Formulations | G | H | I |
|---|---|---|---|
| HEDP | 0.0062 | 0.0062 | 0.0062 |
| TMAH | | | |
| TBPH | 0.0143 | 0.0143 | 0.0143 |
| Triton BG10 | | | |
| Triton X114 | 0.0025 | | |
| PEG (C13EO10) | | 0.0025 | |
| Triton X100 | | | 0.0025 |
| pH | 3.1 | 3.1 | 3.1 |
| Cu (0.2 μm) | 190 | 149 | 145 |
| TEOS (0.13 μm) | 45 | 29 | 24 |

Formulations G, H and I indicate that TBPH is functional with a variety of different surfactants, e.g., Triton X114, PEG, and Triton X100.

TABLE 3

| | Formulations | | | | | |
|---|---|---|---|---|---|---|
| | J | K | L | M | N | O |
| HEDP | 0.0062 | 0.0063 | 0.0062 | 0.0062 | 0.0062 | 0.0062 |
| TMAH | | | | | | |
| TBPH | 0.0143 | 0.0232 | 0.0274 | 0.0232 | 0.0274 | 0.0274 |
| Triton BG10 | 0.007 | | | 0.007 | 0.007 | |
| Triton X114 | | | | | | |
| PEG (C13EO10) | | | | | | |
| Triton X100 | | | | | | 2.5 |
| pH | 3.1 | 7 | 10 | 7 | 10 | 10 |
| Cu (0.2 μm) | 193 | 193 | 224 | 95 | 85 | 147 |
| TEOS (0.13 μm) | 36 | 40 | 29 | 21 | 36 | 24 |

Formulations J through O indicate that TBPH is functional over a wide range of pH values.

Although the foregoing inventive concept(s) has been described in detail by way of illustration and example for purposes of clarity and understanding, it will be appreciated and obvious to those people skilled in the art that certain changes and modifications may be practiced without departing from the spirit and scope thereof, as described in this specification.

What is claimed is:

1. A post CMP cleaning composition which is free of nitrogen atoms and comprises at least one phosphorous base.

2. The post CMP cleaning composition of claim 1 further comprising at least one surfactant.

3. The composition of claim 1 or claim 2 which exhibits a negative zeta potential in the range of from −80 millivolts to about −10 millivolts.

4. The composition of claim 1 or claim 2 wherein the at least one phosphorous base is a phosphonium compound selected from phosphonium hydroxide and alkyl phosphonium hydroxide.

5. The composition of claim 6, wherein the phosphonium hydroxide is tetrabutylphosphonium hydroxide.

6. The composition of claim 2, wherein the surfactant is a nonionic surfactant.

7. A method for cleaning a semiconductor wafer post chemical mechanical polishing to remove CMP residue from the wafer surface comprising the steps of:
(a) forming a processing composition comprising:
at least one phosphorous containing base; and optionally
at least one surfactant, and
(b) contacting the surface of said wafer with the processing composition whereby at least a portion of the CMP residue is removed from the surface of the object.

8. The method of claim 7 wherein the composition exhibits a negative zeta potential in a range of from about −80 millivolts to about −10 millivolts.

9. The method of claim 7 or claim 8 wherein the at least one phosphorus-containing base is a phosphonium hydroxide.

10. The method of claim 9 wherein the phosphonium hydroxide is tetrabutylphosphonium hydroxide and the surfactant is a nonionic surfactant.
